(19) United States
(12) Patent Application Publication
(10) Pub. No.: US 2004/0135565 A1
(43) Pub. Date: Jul. 15, 2004

(54) Microprocessor controlled boost converter

(76) Inventors: Darin J. Douma, Monrovia, CA (US); Andrew P. Homyk, Altadena, CA (US); Luke M. Ekkizogloy, Pasadena, CA (US)

Correspondence Address: R. BURNS ISRAELSEN, WORKMAN NYDEGGER, 1000 Eagle Gate Tower, 60 East South Temple, Salt Lake City, UT, 84111, US

(21) Appl. No.: 10/682,106

(22) Filed: Oct. 9, 2003

Related U.S. Application Data
(60) Provisional application No. 60/418,074, filed on Oct. 10, 2002.

(51) Int. Cl. G05F 1/40

(52) U.S. Cl. 323/283

(57) ABSTRACT

A boost converter for use in a transceiver. The boost converter includes an inductor that is connected to a power supply. A switch is coupled to the inductor and to the return of the power supply when the switch is closed. A diode is coupled to the inductor. A capacitor is coupled between the diode and the return of the power supply with an output voltage being present across the power supply. A microprocessor is coupled to the output voltage. The microprocessor produces a pulse width modulated signal in response to the output voltage. The pulse width modulated signal is coupled through a gate to a pulse train to produce a modulated pulse train. The modulated pulse train is used to control the switch. The modulated pulse train turns the switch on and off in a manner that drives the output voltage to a particular voltage.

### CROSSREFERENCE TO RELATED APPLICATIONS

This application claims the benefit of provisional patent application No. 60/418/074, filed Oct. 10, 2002, titled CONTROLLER-LESS POWER GAIN CIRCUIT which is incorporated herein by this reference.

### BACKGROUND OF THE INVENTION

1. The Field of the Invention

The invention generally relates to the field of fiber-optic communications. More specifically, the invention relates to boost converters used in fiber-optic transceiver and transponder applications.

2. The Relevant Technology

To send data on a fiber-optic cable, the data is typically converted from an electronic form to an optical form. When data is received from a fiber-optic cable, the data is converted from its optical form to an electronic form so that it can be interpreted, for example, by a computer. To convert electronic data to optical data for transmission on a fiber-optic cable, a transmitter optical subassembly (TOSA) is often used. A TOSA uses the electronic data to drive a laser diode or light emitting diode to create the optical data.

When optical data is converted to electronic data, a receiver optical subassembly (ROSA) is used. The ROSA has a photodiode that, in conjunction with other circuitry, converts the light data to electronic data. Because most computers both send and receive data, most computers use both a TOSA and a ROSA to communicate through fiber-optic cables. A TOSA and ROSA can be combined into an assembly generally referred to as a transceiver or a transponder. A transponder is a device similar to a transceiver that also includes hardware for performing operations on data that is sent on the fiber optic cables.

As mentioned above, transceivers and transponders often include photodiodes and laser diodes to effectively accomplish fiber-optic communication. While the computer systems to which the transponders and transceivers connect are able to supply source voltages of around 3 to 5 V, many laser and photodiodes require considerably higher voltages to operate. An avalanche photodiode (APD), for example, may operate in the range of 20 to 50 V.

To convert the 3 to 5 V supply available to the transceiver or transponder to the higher voltages required by the lasers or diodes in the transceiver or transponder, a boost converter such as the boost converter shown in FIG. 1 can be used. FIG. 1 shows a boost converter 110 which includes a power supply 114 that may be a 3 to 5 V supply. The power supply 114 is connected to an inductor 116. The inductor 116 is connected through a switch 118 that may be a field effect transistor (FET) or other switching device to ground 119. The inductor 116 is further connected to a diode 120. The diode 120 is connected to a charge storing capacitor 122. The charge storing capacitor 122 is also connected to ground 119.

The output voltage 124 across the capacitor 122 is fed into a controller 112. The controller 112 generates a pulse stream 126 that is fed into the switch 118 for turning the switch 118 on and off. The frequency of the pulse stream is a design factor that affects the size of the inductor 116 and the capacitor 122. For example, the frequency of the pulse stream 126 and the size of the capacitor 122 may be chosen such that voltage ripple and noise are minimized when a load is driven by the output voltage 124. A higher frequency pulse stream, for example, permits a smaller capacitor to be used.

Generally, the controller 112 should respond with a quick step response. If a load changes suddenly, either the capacitor 122 will begin to discharge more quickly or begin to overcharge. The controller 112 should therefore respond quickly to prevent the output voltage 124 from dropping too low or from rising too high. Alternatively, to prevent the output voltage 124 from dropping too low, a larger capacitor 122 may be used, but at the added expense of size and possibly a more expensive capacitor.

Illustratively, the boost converter 110 of FIG. 1 operates first with the switch 118 in an off position. The circuit is nonetheless completed from the power supply 114 through the inductor 116 further through the diode 120 and through the capacitor 122 to the ground 119. This causes a charge across the capacitor 122 and an output voltage 124 across the capacitor 122. Without any other action, the maximum voltage at the output voltage 124 will be the voltage of the power supply 114 minus a voltage drop across the diode 120 if the capacitor is allowed to fully charge in this state. To boost the output voltage 124, the pulse stream 126 is fed into the control of the switch 118. When the pulse stream 126 is high, a current flows from the power supply 114 through the inductor 116 through the switch 118 to ground 119. When the pulse stream goes low, the switch 118 is shut off such that current cannot flow through that path to ground 119. The inductor 116 has energy stored within it that needs to be dissipated. The only remaining path for this energy is through the diode 120 and the capacitor 122 to ground 119. However, for current to flow through the diode 120, the voltage on the anode side of the diode must be greater than the voltage on the cathode side of the diode 120. Diodes exhibit a diode drop which is a voltage differential between the voltage at the anode and cathode necessary for current to flow through the diode. Typically, the diode drop is a value between 0.5 and 0.7 V. For the inductor 116 to dissipate power through the diode 120 the voltage at the anode of the diode 120 increases to a voltage above that across the capacitor 122 by the value of the diode drop resulting in current flow through the capacitor 122 and the charging of the capacitor 122 to a voltage higher than the voltage that was previously across the capacitor. By using the pulse stream 126 to continuously turn the switch 118 on and off, the output voltage 124 across to the capacitor 122 can be incrementally raised to a value suitable for driving lasers and photodiodes.

Without some sort of feedback, the voltage across the capacitor 122 may continue to rise above the desired output voltage range. In boost converter applications, a controller 112, which also generates the pulse stream 126, is connected to the output voltage 124. Using common feedback principles, the pulse stream 126 can be applied to the switch 118 in a manner that controls the voltage output voltage 124. This is usually done by interrupting the pulse stream 126 for a period of time to allow the output voltage 124 to decay. When the output voltage 124 has decayed sufficiently, the pulse stream 126 is again applied to the switch 118.

The controller 112 is commonly a general purpose, analog hardware based, commercially available part. The controller 112 has a quick response time so that as the output voltage fluctuates, the controller can compensate for these fluctuations relatively quickly. The controllers are generally optimized for the particular application in which they are used by the person who implements the controller.

The controllers are designed such that they can be optimized for a particular application. Typically, the controller has a number of signal I/O (input/output) pins physically present on the controller package. A more flexible controller requires more pins on the controller package. The controller implementer connects various discrete components such as resistors, capacitors, inductors, diodes etc. to these pins. Controllers may be designed such they are space saving in that they have fewer pins. Fewer pins result in fewer optimization options and hence a less flexible controller.

In fiber-optic communications is often desirable to implement the transceiver and transponder in a small package. One reason for this is because of the high frequencies at which fiber-optic transceivers and transponders operate. When electrical components operate at high frequencies, it is desirable to reduce the distances that the high-frequency signals travel to reduce transmission errors. Thus, by reducing the transceiver or transponder size, signal travel distance can be reduced. Additionally, it is desirable to implement smaller transceivers and transponders simply for saving space in the location where the transceiver or transponder is installed. Therefore, trade-offs are often made between the amount of customization that is available for a controller and the amount of space to implement the transceiver or transponder.

### BRIEF SUMMARY OF THE INVENTION

One embodiment of the invention is implemented in a transceiver for use in fiber optic communications. The transceiver includes a boost converter for supplying voltages to diodes that require voltages greater than those available from power supplies supplying the transceiver. The boost converter includes an inductor connected to a power supply. The inductor is further connected to a switch, the switch completing a circuit through the inductor to ground when the switch is on. A diode is coupled to the inductor. A capacitor is connected to the cathode of the diode and to ground such that an output voltage is generated across the capacitor. A microprocessor monitors the output voltage and generates a pulse width modulated signal in response to the output voltage. The pulse width modulated signal is gated with a pulse train to produce a modulated pulse train. The modulated pulse train is used to control the switch. By controlling the switch with the modulated pulse train, an output voltage can be boosted to the requisite or target levels.

Another embodiment of the invention includes a method of generating a voltage in a transceiver for powering diodes used in the transceiver using a boost converter. The method includes receiving a current from a power supply. The current is passed through an inductor. From the inductor, the current is passed through a diode. From the diode, the current is passed through a capacitor to create an output voltage. The output voltage is fed into a microprocessor. The microprocessor generates a pulse width modulated signal in response to the output voltage. The pulse width modulated signal is gated with a pulse train to produce a modulated pulse train. A switch is controlled with the modulated pulse train. The switch is connected to the inductor such that current passes through the inductor and through the switch to ground when the switch is on. The switch configuration is further such that stored energy in the capacitor causes the current to pass through the diode and through the capacitor when the switch is switched from on to off.

Embodiments of the invention have various advantages over what is known in the prior art including the ability to implement a flexible implementation without unnecessarily increasing size or component count. For example, the invention utilizes a microprocessor, which may already be present in the transceiver design, to control the boost converter. In this way, different gain characteristics can be implemented without the need to add additional external components to a boost converter controller, thus saving space, and reducing cost and complexity of the physical transceiver.

One embodiment of the invention implements a compact and flexible boost converter in a transceiver. Some embodiments of the invention minimize the number of components used in a transceiver design by using a microprocessor already present in the design and needed for other operations in the transceiver as a portion of the controller for the boost converter in the transceiver.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a boost converter; and

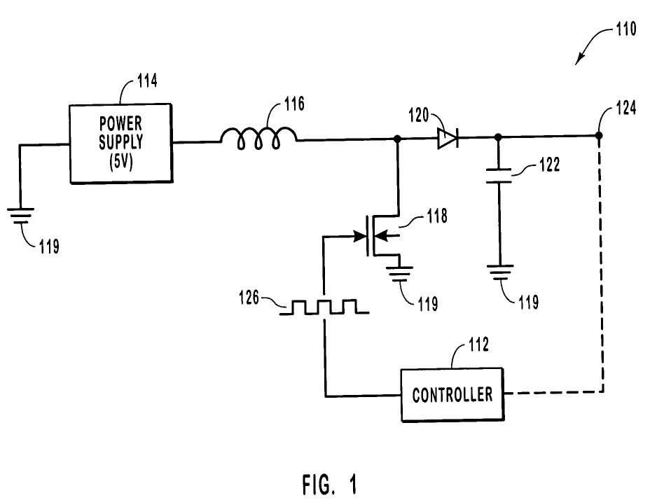

FIG. 2 illustrates one embodiment of a boost converter that uses a microprocessor to gate a high frequency signal to the boost converter.

### DETAILED DESCRIPTION OF THE PREFERRED EMBODIMENTS

In general applications implementing boost converters, a quick response time is important. In the case of transceivers used in fiber optic communication, however, the loads driven by the output voltage of the boost converter have a slow step response. As a result, a quick response time becomes less important. As previously mentioned, customizable highly flexible controllers are not typically implemented in small packages.

Embodiments of the present invention make use of components that are normally utilized already present for other purposes in a transceiver or transponder to also implement the functionality of the controller in the boost converter in addition to their original function. A microprocessor that is commonly implemented in transceiver and transponder designs can be used to simultaneously act as a controller and still perform the other functions commonly performed by the microprocessor. Embodiments of the present invention thus save space and retain the ability to customize the controller, for example, in code.

In many applications, a microprocessor is not suitable for use as a boost converter controller. This is because of a microprocessor's relatively slow response time and the relatively low frequency of the pulse train that it is able to generate when compared to a general purpose boost converter controller. However because, the loads in a fiber optic transceiver are typically switched on and off at a very quick rate such as 1 GHz, to a boost converter operating at lower frequencies such as below 10 MHz the current requirement of the high frequency loads appear to the controller to be essentially constant over time. Thus, the high frequency loads do not require as fast a response time from a boost coverter controller.

Contrast this example with the general case such as when a load may be on for a relatively long period of time and then off for a relatively long period of time. When the load switches on in this case, the charge on the capacitor may be drained too quickly and result in a reduced output voltage change if the response time in the boost converter to the change in load is not relatively quick,. When the load switches off, the capacitor may be overcharged if the response time in the boost converter to the change in load is not relatively quick.

In the case of the fiber-optic transceiver, the most significant long term change in load usually results from changes in temperature of the laser or photo diode. A change in temperature of the laser or photo diode causes a corresponding change in the amount of current needed to drive the laser or photo diode. However, temperature changes are sufficiently gradual such that a microprocessor is fast enough to compensate for such changes.

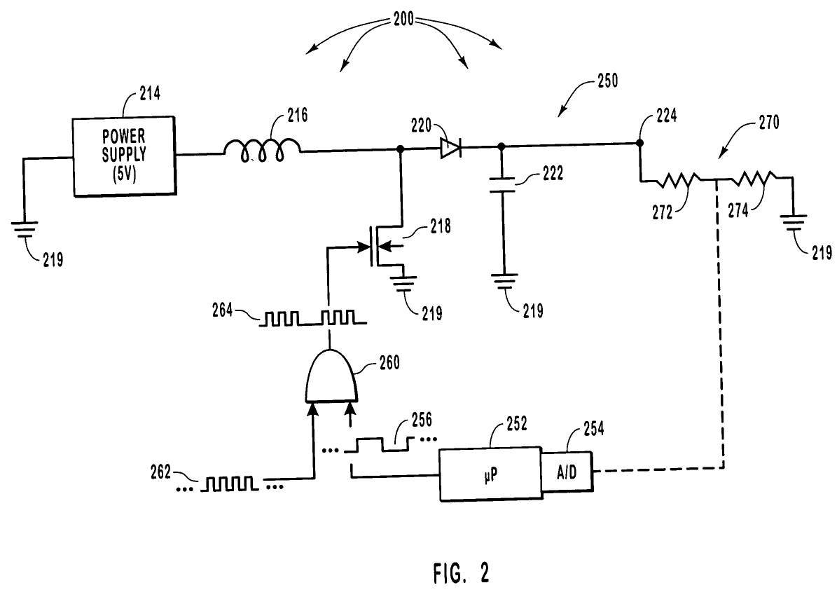

The microprocessor is capable of controlling the output voltage while compensating for temperature changes of the loads in fiber-optic transceiver applications. However, the microprocessor, even in transceiver applications may not be able to produce a sufficiently fast pulse train as the input to the switch of the boost converter to optimize the charge capacitor. In one embodiment, a higher frequency pulse train can be gated with a control signal generated by the microprocessor to control the switch. One embodiment of the present invention showing such an arrangement is shown in FIG. 2.

Referring now to FIG. 2, one embodiment of the present invention is shown embodied in a transceiver 200. FIG. 2 illustrates a power supply 214 that may be a 3-5 Volt power supply such as those provided by a computer system. The power supply 214 is connected to an inductor 216. The inductor 216 is connected through a switch 218 that may be a field effect transistor (FET) or other switching means to ground 219. The ground 219 is also connected to the return of the power supply 214. The inductor 216 is further connected to a diode 220. The diode 220 is connected to a charge storing capacitor 222. The charge storing capacitor is also connected to ground 219 and hence to the return of the power supply 214. The output voltage 224 across the capacitor is fed through a feedback loop into a microprocessor 252.

The control of the switch 218 is connected through a gate 260 to a pulse train 262 that in one embodiment of the invention may be between about 500 KHz and 10 MHz. The pulse train 262 may be produced from any convenient source such as the clock for the microprocessor 252 or any other source. The gate 260 is also connected to a signal produced by the microprocessor 252 that is a pulse width modulated signal in this example. The pulse width modulated signal 256 modulates the pulse train 262 at the control of the switch 218.

Regarding the gate 260, although an AND gate is shown, those skilled in the art understand that a variety of gates or other electronic circuits may be used to modulate the pulse stream 262, including but not limited to AND, OR, NOR, NAND and their variants. While the pulse width modulation signal 256 and/or pulse train 262 may need to be adjusted, or other logical operations performed depending on which type of gate is used, any of the various gates may be used. Additionally, devices such as flip-flops, transistor switches or other devices may be used to modulate the pulse train 262 with the pulse width modulated signal 256.

The pulse width modulated signal 256 may be at any frequency that the microprocessor 252 is able to produce and that is of a sufficient speed to meet the step response requirements in fiber-optic transceiver and transponder applications. In one embodiment of the invention, a 30 KHz signal is used. Other embodiments of the invention allow of the use of signals between 10 KHz and 1 Mhz. A pulse width modulated signal may have an adjustable duty cycle of anywhere from 0 to 100%. In one embodiment of the invention, at 0% duty cycle, the pulse width modulated signal is always low. At 100%, the pulse width modulated signal is always high. At for example 75%, the pulse width modulated signal is high for 75% of the time and low for 25% of the time. The duty cycle of the pulse width modulated signal 256 is adjusted depending on feedback fed into the microprocessor 252.

One exemplary feedback loop is shown in FIG. 2. The feedback loop feeds a signal derived from the output voltage 224 back into the microprocessor 252 in accordance with common feedback principles. In the embodiment shown in FIG. 2 the derived signal is fed into an analog to digital (A/D) converter 254 such that a digital signal derived from the output voltage can be fed into the microprocessor 252. The A/D converter 254 in one embodiment of the invention may be included as a part of the microprocessor 252. The particular embodiment illustrated in FIG. 2 includes a voltage divider 270 that in one embodiment of the invention is a combination of resistors 272 and 274. Those skilled in the art understand that a voltage divider can be designed by choosing resistor 272 and 274 values in light of the current drawn by the A/D converter 254 to cause the voltage fed into the A/D converter to be a certain percentage of the output voltage 224. This is done in cases where the A/D converter 254 cannot support voltages that are at a level of the output voltage 224.

By comparing the value of the derived digital signal to a target output voltage value, the microprocessor 252 can adjust the pulse width modulated signal 256 that turns the switch 218 on and off in a manner to move the output voltage 224 to a target output voltage value.

By using a microprocessor instead of a boost controller, various embodiments of the invention can be implemented with advantageous features over what has previously existed. For example, using a microprocessor allows for a more flexible implementation. As previously stated, boost converter controllers require external components to implement various features. Transceiver and transponder designers, however, often seek to limit the number of components used in the construction of the transceiver or transponder. By using a microprocessor, flexibility can be implemented in the code used by the microprocessor without the need to add additional hardware.

One illustrative example is the different needs of a transceiver or transponder when it is first started up as compared to when the transceiver or transponder has been running for some time. When the transceiver first starts up, there is no charge on the output capacitor and thus the output voltage is zero volts. It may be desirable to ramp up the output voltage very quickly. A feedback gain may be appropriately set in the code used by the microprocessor such that a quick ramp up is achievable. When the transceiver or transponder is in a steady state, such a gain is probably not appropriate and may cause the boost converter circuit to be unstable. Thus, a different gain may be programmed into the microprocessor for operation at steady state.

While the invention has been described with reference to one embodiment, it should be understood the many various embodiments fall within the scope of the invention. As such, the following description describes embodiments of the invention in general terms. Generally, one embodiment of the invention may include a means for powering. The means for powering may be a device such as the power supply 214 shown in FIG. 2. The power supply of FIG. 2 may be the power supply of a computer system that uses the fiber optic transceiver in which the boost converter 250 is implemented. Alternatively, the power supply 214 of FIG. 2 may be an external dedicated power supply for powering the transceiver or transponder. Such power supplies may be switching power supplies, linear power supplies, or any other appropriate power supply.

Embodiments of the invention may include a means for inducing. The means for inducing is an energy storing device such as the inductor 216 shown in FIG. 2. Any means for inducing that stores energy as the result of current being passed through it may be used.

Embodiments of the invention may also include a means for switching coupled to the means for inducing. The means for switching is used to complete a circuit including the means for powering, and the means for inducing. By completing the circuit, the means for switching allows energy to be stored in the means for inducing. The means for switching may be a device such as a FET transistor. The means for switching may also include other types of transistors, logic gates, electromechanical devices such as relays, solid state relays, or any other suitable switching device.

Embodiments of the invention may also include a means for storing. The means for storing stores a charge to maintain an output voltage. One example of the means for storing is illustrated in FIG. 2 as the capacitor 222.

Embodiments of the invention may also include a means for blocking coupled between the means for storing and the means for inducing. The means for blocking has characteristics which allow energy stored in the means for inducing to be transferred from the means for inducing to the means for storing, but does not allow energy from the means for storing to be transferred to the means for inducing or the means for switching. Specifically, the means for blocking requires that a voltage differential exist across the means for blocking for boosting the voltage across the means for storing. One example of a means for blocking is shown in FIG. 2 as the diode 220. While a diode is shown, other devices may be used as well such as the junctions of various transistors or other blocking devices.

Embodiments of the present invention further may include a means for controlling. The means for controlling monitors an output voltage across the means for storing and generates control signals in response to control the means for switching. The means for controlling further controls other functions of a transceiver or transponder other than those associated with the boost converter. The means for controlling may be a device such as the microprocessor 252 shown in FIG. 2. The microprocessor may produce the pulse width modulated signal 256 as the control signal.

Embodiments of the present invention may further include a means for gating. The means for gating has as an input the control signal from the means for controlling. The means for gating uses the control signal to modulate a pulse train such as pulse train 262 which modulated pulse train is used to control the means for switching. The means for gating may include the AND gate 260 shown in FIG. 2. Other means for gating may also be used such as other types of logical gates, transistor amplifiers and switches, solid state or mechanical relays, and other solid state and mechanical switching devices.

Embodiments of the present invention may further include a means for digitizing coupled to the means for storing for converting the output voltage to a digital signal suitable for use by the means for controlling.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A boost converter for use in a transceiver to generate an output voltage that is greater than a voltage available to the boost converter, the boost converter comprising:
an inductor adapted to couple at a first end of the inductor to a power supply;
a switch that is adapted to couple a second end of the inductor to the return of the power supply when the switch is closed;
a diode coupled at the anode to the second end of the inductor;
a capacitor coupled to a cathode of the diode and adapted to couple to the return of the power supply, the capacitor adapted to maintain an output voltage;
a microprocessor for monitoring the output voltage, wherein the microprocessor generates a pulse width modulated signal in response to the output voltage; and
a gate coupled to the pulse width modulated signal and to a pulse train, the gate producing a modulated pulse train, the gate further coupled to the switch such that the modulated pulse train can be used to control the switch and move the output voltage to a target voltage.

2. The boost converter set forth in claim 1, the pulse train being a signal between about 500 kHz and 10 MHz.

3. The boost converter set forth in claim 1, the pulse width modulated signal being a signal between about 10 kHz and 1 MHz.

4. The boost converter set forth in claim 1, wherein the gate is at least one of an AND gate, a transistor switch, and a field effect transistor.

5. The boost converter set forth in claim 1, further comprising an analog to digital (A/D) converter coupled between the output voltage and the microprocessor to derive a signal usable as a feedback signal by the microprocessor.

6. The boost converter set forth in claim 5 further comprising a voltage reduction circuit coupled between the output voltage and the A/D converter to derive a signal that is at a level that is supported by the A/D converter.

7. The boost converter of claim 6 wherein the voltage reduction circuit is a voltage divider.

8. The boost converter of claim 5, wherein the A/D converter is comprised of the microprocessor.

9. The boost converter of claim 1, wherein the switch is a field effect transistor.

10. A boost converter for use in a transceiver to generate an output voltage that is greater than a voltage available to the boost converter from a power supply, the boost converter comprising:
means for inducing coupled to a power supply;
means for switching coupled to the means for inducing, the means for switching adapted to allow a current to flow from the power supply through the means for inducing;
means for storing coupled through a means for blocking to the means for inducing, the means for storing adapted to maintain an output voltage caused by current flowing through the means for blocking to the means for storing;
means for controlling coupled to the means for storing, the means for storing being adapted to monitor the output voltage across the means for storing and for generating a control signal to control the means for switching; and
means for gating coupled to the means for controlling and the means for switching, the means for gating using the control signal to modulate a pulse train to control the means for switching.

11. The transceiver boost converter as set forth in claim 10, further comprising a means for digitizing coupled between the means for storing and the means for controlling, the means for digitizing adapted to derive a signal from the output voltage that is useable by the means for controlling.

12. A boost converter for use in a transceiver to generate an output voltage that is greater than a voltage of a power supply available to the boost converter, the boost converter comprising:
a capacitor used to generate an output voltage, wherein the capacitor is coupled to an inductor through a diode;
a switch that is coupled to the diode and the inductor such that current flows through the diode and the capacitor when the switch is off and such that current flows through the switch when the switch is on;
a microprocessor that monitors the output voltage and that generates a pulse width modulated signal in response to the output voltage; and
a gate generates a modulated pulse train by gating the pulse width modulated signal with a pulse train, wherein the modulated pulse train turns the switch on and off in a manner that raises the output voltage to a target voltage.

13. A boost converter as defined in claim 12, wherein the gate is one of an AND gate, a transistor switch, and a field effect transistor.

14. A boost converter as defined in claim 12, wherein the pulse width modulated signal being a signal between about 10 kHz and 1 MHz.

15. A boost converter as defined in claim 12, wherein the pulse train signal is between about 500 kHz and 10 MHz.

16. A boost converter as defined in claim 12, wherein the switch is a field effect transistor, wherein a gate of the field effect transistor is connected to the modulated pulse train.

17. A boost converter as defined in claim 12, further comprising an analog to digital (A/D) converter coupled between the output voltage and the microprocessor to derive a signal usable as a feedback signal by the microprocessor.

18. The boost converter set forth in claim 17, further comprising a voltage reduction circuit coupled between the output voltage and the A/D converter to derive a signal that is at a level that is supported by the microprocessor.

19. The boost converter of claim 18, wherein the voltage reduction circuit is a voltage divider.

20. A method of generating a voltage in a transceiver for a diode used in the transceiver, the diode requiring a voltage greater than voltages available to the transceiver via an external power supply the method comprising:
receiving a current from a power supply;
passing the current through an inductor;
passing the current from the inductor through a diode;
passing the current from the diode through a capacitor to create an output voltage;
feeding at least a portion of the output voltage into a microprocessor;
at the microprocessor, generating a pulse width modulated signal in response to the output voltage;
gating the pulse width modulated signal with a pulse train to produce a modulated pulse train; and
controlling a switch with the modulated pulse train, the switch connected to the inductor such that the current passes through the inductor and the switch to ground when the switch is on and such that stored energy in the inductor causes the current to pass through the diode further through the capacitor when the switch is switched from on to off, thereby controlling the output voltage.

21. The method of claim 20, wherein feeding at least a portion of the output voltage into a microprocessor further comprises:
feeding the output voltage into an analog to digital converter; and
feeding the output of the analog to digital converter into the microprocessor.

22. The method of claim 20, wherein feeding the output voltage into a microprocessor comprises using a voltage divider to feed a percentage of the output voltage into the analog to digital converter.
